(19) United States
(12) Patent Application Publication
(10) Pub. No.: US 2016/0011430 A1
(43) Pub. Date: Jan. 14, 2016

(54) HOLOGRAPHIC 3D EYEWEAR FOR VIDEO GAMING

(71) Applicant: Iyin Sky, Bronx, NY (US)

(72) Inventor: Iyin Sky, Bronx, NY (US)

(21) Appl. No.: 14/325,369

(22) Filed: Jul. 8, 2014

(51) Int. Cl. G02B 27/22; G02B 3/06

(52) U.S. Cl. CPC G02B 27/2242; G02B 3/06

(57) ABSTRACT

3D eyewear that uses Cylindrical Lens that stretched across the viewers eye viewing space, while capturing and curving light (into pincushion and/or barrel distortion) from an image on a screen (such as 3D video games, videos, and pictures) and turn it into a Holographic 3D scene with depth. The technology depends on the viewers natural monocular cues combined with the optical distortion of the Lens to acquire this Holographic 3D effect. The eyewear has three different parts: the eyewear frame, eyewear drawer, and Cylindrical Lens. No special applications or devices are are need to this method of 3D. The only thing that is needed is the 3D eyewear, monitor, and normal 3D video game, video or picture to view True 3D with Depth (3D Holographic scene). Note: This method of 3D aims mostly towards 3D video gaming.

### BACKGROUND

This 3D method aims to fix the problem with 3D eyewear needing Both eyes, and two separate identical scenes shown at a different camera angle on a screen in order to see a 3D scenes with depth and prominence, as well as 3D needing any special devices or applications when playing 3D video games, viewing images and videos. With this method of choice people can now view 3D using one or both eyes, while looking at one single image on mostly any screen (i.e. computer screens, smart phones, laptops, and large Televisions) with high depth and prominence. With the 3D method being used here 3D enabled Television are not needed; the eyewear and image is all that's needed. However, most other 3D devices that are already in the market (i.e. stereoscopic 3D for video gaming) require a specific type of 3D enabled monitor to acquire 3D with their methods. Another issue that this method aims to fix is the inconsistency with 3D rendered games like with shutter glasses. Shutter glasses which are used to play 3D games are not consistent with rendering shadows and lighting correctly, which result in some games being better than others in 3D. Shadows a lighting are sometimes out of place depending on how they render, drawn on shadows and lighting or rendered based on physics. However, The method being used can take One flat 3D Scene with the right spatial relationships between reference objects and be viewed with depth with a single lens, rendering shadows and lighting correctly. This is do to the fact that the method only needs one image to produce a 3D effect, leaving shadows, lighting and other 3D effects in tact and in place inside of 3d video games. This 3D method also allows no frame rate drops coming from having two separate scenes, since the this 3D method only needs one scene in order to work.

This method being used, uses Cylindrical lenses inside eyewear to acquire monocular cues from a regular monitor is similar to traditional holograms which also uses Cylindrical lens in a different fashion is better than stereoscopic when it comes to natural viewing. The eyes will have natural accommodation and vergence of an object in a scene when focusing on it's actual position in it's space; unlike stereoscopic technology which an objects position in it's scene is made based on the different angles of two similar images, giving eye strain.

Similar to holograms, this method of using Cylindrical lens inside of eyewear aims to give the viewer unlimited depth. However, it's not aimed to create a hologram, but aims to give 3D depth to a complete scene from a normal image (ie. video game, video, and picture) when looking upon any television or monitor.

### BRIEF SUMMARY OF THE INVENTION

The invention is 3D eyewear that allows the viewer to see a single image such as a video game, video or an image on a screen, in true 3D with Depth. The 3D eyewear invention is the only thing needed to see 3D with depth. No special television, screen, or applications are needed to view 3D images. Only thing that's need is the 3D eyewear and a video game, picture, or videos.

The 3D eyewear has three different parts. First is the eyewear frame, which is simply made to fit onto a persons head. Second is the eyewear drawer, which connects to the eyewear frame. Third is the lens which goes inside of the eyewear drawer.

In order to see true 3D, the 3D eyewear uses a wide cylindrical lens. The cylindrical lens receives plane wavefront of light from a single image on a normal monitor and turns the light into a curved wavefront of light for the human eye. The human eye then does the rest of 3D rendering depth with it's natural abilities of monocular cues. The end result of a curved wavefront rapping around the viewers eyes combined with monocular cues, is the viewer perceiving the flat 3D scene on a monitor as a 3D scene with actual depth.

### BRIEF DESCRIPTION OF THE DRAWINGS

FIG 1. Figure Shows all parts of the 3D eyewear. 1: Eyewear Frame. 2a: Eyewear Drawer (short extension). 2b: Eyewear Drawer (long extension). 3: Represents Cylindrical lens of any shape.

FIG 2. Figure of 3D eyewear parts connected as a whole including 1: Eyewear Frame 2a. Eyewear Drawer (short extension) and 3: Cylindrical lens.

FIG 3. Figure of 3D eyewear parts connected as a whole including 1: Eyewear Frame 2: Eyewear Drawer (long extension) and 3: Cylindrical lens.

FIG 4. Demonstration of a viewer looking through the 3D eyewear onto a screen, visualizing a true 3d scene with depth. 4: Viewer wearing 3D eyewear. 4: Three dimensional scene projected from a screen as light with pincushion or barrel distortion through the lens. 6: Image on a monitor such as video games, videos and pictures.

### DETAILED DESCRIPTION AND BEST MODE OF IMPLEMENTATION

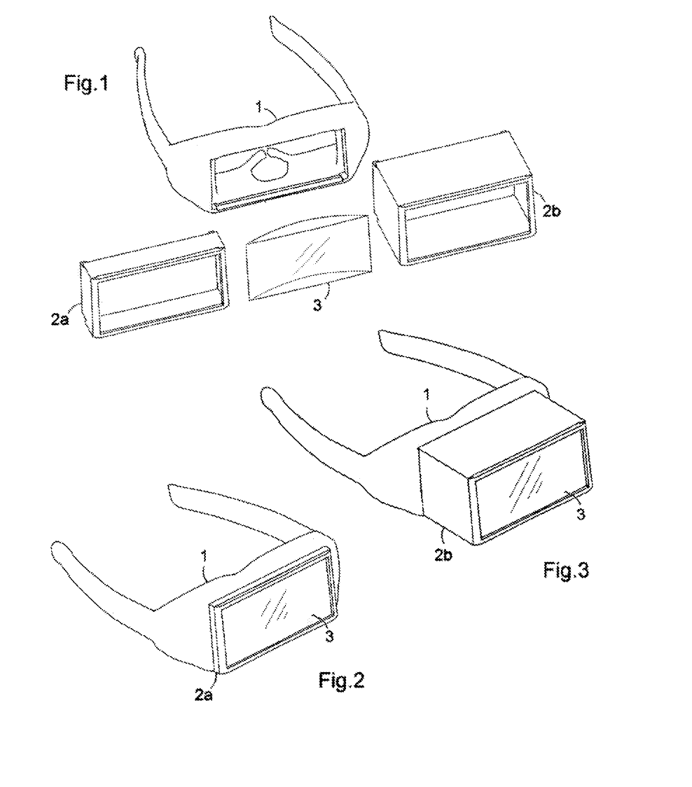

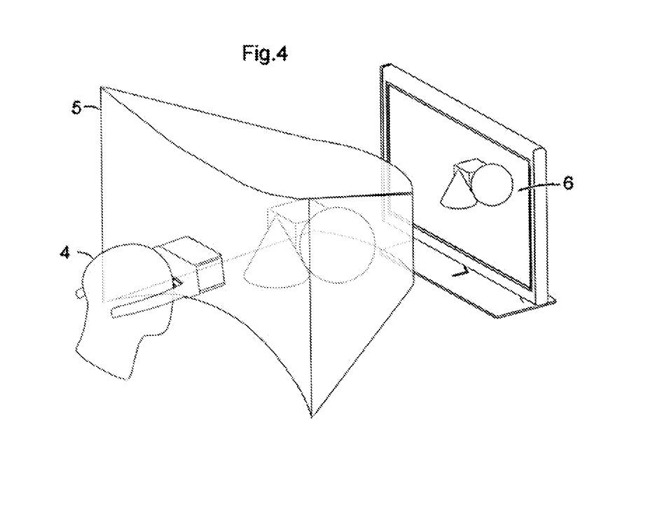

The Design of the 3D eyewear is made out of three parts that are combined that allow the viewer to see flat three dimensional scene (video games, videos and pictures) from a monitor, in 3D with Depth and prominence (FIG. 4). First is Eyewear Frame (FIG. 1 Part. 1): The frame of the eyewear is meant to fit on the head of a person. Second is the Eyewear Drawer (FIG. 1 Parts. 2a,2b): The eyewear drawer is meant to connect to the eyewear frame (FIG. 1 Part. 1). Last and most important is the Cylindrical Lens (FIG. 1 Part. 1): The lens is meant to be placed into the eyewear drawer (FIG. 1 Parts. 2a,2b): All when combined (FIG. 2, FIG. 3) and worn, the viewer (FIG. 4 Part. 4) can then view a scene on a monitor (FIG. 4 Part. 6) as a scene with true 3D depth (FIG. 4 Part. 5).

Eyewear frame (FIG. 1 Part. 1): The preferred shape of the eyewear frame is similar to those of glasses with a temple arm for the ears and opening in the front for the eyes. The temple arms may have an adjustable strap to it, supporting the eyewears weight on the viewers head. The opening in the front of the eyewear frame singular wide and large across, past the width of both eyes, from left to right just so that the viewer can see through. There are no specific sizing requirements for the head shape as the size doesn't directly affect the 3D image with depth. Only important is that the frame can fit onto a head, and that eyes can see through the opening. Note: The Head frame doesn't need a temple arms, just as long has the 3D eyewear can be supported on the face. May use straps that fit around the head in place of temple arms.

Eyewear Drawer (FIG. 1 Parts. 2a and 2b): The Eyewear Drawer is made to connect the lens to the eyewear frame (FIG. 1 Part. 1), thus in combination being worn by the viewer (FIG. 4 Part. 4). The eyewear drawer comes in two separate designs, one long (FIG. 1 Part. 2b) and one short (FIG. 1 Part. 2a). The long eyewear drawer is made to increase depth at a higher power in a 3D scene by increasing the focal length. The short eyewear drawer is made for lower power of depth in a 3D scene with a smaller focal length. Focal lengths effects how strongly lens diverge or converge light. So the long eyewear drawer with with the lens will give depth in a 3D scene at it's fullest around 3 to 10 inches away from the viewers eyes. Where as the short eyewear drawer with the lens, up to 2 inches, will have lower convergence or divergence power resulting in a 3D scene with low depth.

Cylindrical Lens (FIG. 1 Part. 3): The lens is the most important part for seeing 3D with depth and prominence (FIG. 4 Part. 5) when placed into the lens drawer (FIG. 3 Part. 3, FIG. 2 Part. 3). By default the lens is Cylindrical Plano-Convex or Plano-Concave, changing shape at the width from left to right, converging or diverging rectangular Lens, made out of Acrylic plastic, Glass, or any other type. This type of single lens is best because it reduces distortions and optical aberrations, giving clarity to a 3D image. The lens will be made of any power that's thin and clear enough for the human eye. Note: the lens may also be of any custom shape possible with Cylindrical Lens that curves around the view of the eyes.

The material used by default is Acrylic plastic, other plastics, Glass or any other possible materials, however can be mad of other plastics and materials. Some list of other lens that may be used other than the default materials are: Glass, Polycarbonate, Mid to High index plastic, Cr-39. Note: Other lens materials may be used as well. Shapes: Aspheric Cylindrical Plano-Convex or Plano-Concave, changing shape at the width, converging or diverging rectangular Lens, and any other possible Cylindrical lens shapes can be used.

When all peaces are assembled together (lens inside the lens drawer, and then the lens drawer inside the frame) (FIG. 2, FIG. 3) the viewer places the eyewear on the head (FIG. 4 Part. 4) and sits in front of a screen (FIG. 4 Part. 6) that the light can be captured by the curved lens. The light source coming into the lens from the screen is at first flat waves of light known as incident wavefront or planes and collimated light, and then once it passes through the lens it becomes a spherical wavefronts of light rapped around the persons view. In short words, once the eyewear is worn and in front of the screen, the lens takes light from the screen, and the wearer's eyes takes light from the lens leaving a scene to be interpreted as a seen with depth. This distortion of light is a Pincushion's or Barrel 3D scene with Depth (FIG. 4 Part. 5).

The Operations of the Lens is to turn a flat image on a monitor (Video games, videos and images) (FIG. 4 Part. 6) into 3D with depth and prominence (FIG. 4 Part. 5): The findings is that a Cylindrical lens (FIG. 1 Part. 3) has optical distortions (pincushion and barrel distortion) (FIG. 4 Part. 5) that can highly make a viewer feel as if they're in an actual three dimensional space (FIG. 4 Part. 5) when looking at images (FIG. 4 Part. 6). These distortions or wavefront that a Cylindrical has, when placed in front of the viewers view area, stretches across the face, and helps produce depth in a scene viewed from a any screen.

The Operation of the eyes and it's perception of depth: Because this method of viewing light from a screen in 3D with depth and prominence can be view with either both eyes together or separately, the depth of perception is based on Monocular vision. List of Monocular cues: Accommodation, Motion Parallax, Depth from motion, Relative size, Familiar Size, Occlusion, Elevation, Texture gradient, Shading and Lighting, Kinetic depth effect, Perspective, Aerial perspective, Curvilinear perspective.

One of the most important Monocular cue is Accommodation: This the lens inside the eye adjust to the distance in a scene. When looking and focusing far in a scene, the lens inside the eyes stretch and become thinner When the focus in near, the lens become fuller. This method of viewing true 3d being used supports accommodation which means there is no eye strain, unlike the current 3d technology that uses stereoscopic images.

Another important Monocular cue is Curvilinear perspective: There are two cuvilinear perspectives that the curved wave front from a cylindrical lens. They are barrel distortion and pincushion distortion. These are stretches across a scene that can give the viewer a really good sense of being in an actual 3D scene (FIG. 4 Part. 5). This is especially good with 3D video games being that they have perception distortion and accurate spacing between reference objects. Curvilinear perspective and perspective distortion combined is an absolute combination that puts a person in the middle of a 3D scene with true Depth.

Another combination of Monocular cues as far positions of objects are Motion Parallax, Depth of motion, and Elevation: Motion parallax is when objects that are closer move faster than objects further in a scene (ie. When driving). Depth from motion is when objects change size based on positioning in a scene. When objects get closer they get bigger causing retinal projection to become larger, which gives the effect that an object is coming closer to the viewer. Elevation is when the horizon is used as a cue of distance. Objects that are closer to the horizon is viewed as far, and objects more away from the horizon seem closer. Motion parallax, Depth of motion and Elevation together can give a strong sense of object positioning in a scene.

1. Holographic eyewear that turns any normal image (such as video games, videos, pictures) displayed on any screen (monitors, laptops, handhelds, etc.) into a 3D image with Depth Perception by utilizing eyewear comprising parts such as:
Eyewear frame (of any shape or style) that can fit the viewers head including; Extention of frame, as an attachment or embedded as a whole of the frame, nearest or anywhere up to 15 inches away from viewers eyes encasing;
Cylindrical Lens of any possible materials and shape, fitting across the viewer's eye view space, connected to the end of the extention of frame or frame it's self;
which the lens intend to captures and bend light from an image on the screen with pincushion distortion and/or barrel Distortion
giving the scene depth to the viewer when in combination:
viewer wears the 3D eyewear while looking apon a screen with a video game, video, or picture image, and then seeing the displayed image as a 3D Hologram or image with depth.
